(19) United States
(12) Patent Application Publication
(10) Pub. No.: US 2014/0003819 A1
(43) Pub. Date: Jan. 2, 2014

(54) CLOUD BASE STATION IN FIXED-MOBILE CONVERGED ACCESS NETWORK AND OPERATION METHOD THEREOF

(71) Applicant: Electronics and Telecommunications Research Institute, Daejeon (KR)

(72) Inventors: Seung Hyun Cho, Daejeon (KR); Seung Il Myong, Daejeon (KR); Kyeong Hwan Doo, Daejeon (KR); Jie Hyun Lee, Daejeon (KR); Sang Soo Lee, Daejeon (KR); Jong Hyun Lee, Daejeon (KR)

(73) Assignee: Electronics and Telecommunications Research Institute, Daejeon (KR)

(21) Appl. No.: 13/930,320

(22) Filed: Jun. 28, 2013

(30) Foreign Application Priority Data
Jun. 29, 2012 (KR) 10-2012-0070947
Jun. 11, 2013 (KR) 10-2013-0066740

(51) Int. Cl. H04W 72/04

(52) U.S. Cl. CPC H04W 72/04
USPC 398/96; 370/336

(57) ABSTRACT

Disclosed is a cloud base station in an orthogonal frequency division multiplexing (OFDM)-based fixed-mobile converged access network and an operation method thereof. The cloud base station may include a physical (PHY) layer unit to perform a quadrature amplitude modulation (QAM) of a parallel signal received from a media access control (MAC) layer per subcarrier, and an optical orthogonal frequency division multiplexing (OFDM) transceiver to transform the QAM modulated subcarriers into a time domain to generate an OFDM sample per subcarrier, add a cyclic prefix (CP) and control information to for operating an enhanced radio unit (eRU) to the OFDM sample per subcarrier to generate a downstream signal, and transmit the downstream signal.

### CROSS-REFERENCE TO RELATED APPLICATION

This application claims the priority benefit of Korean Patent Application No. 10-2012-0070947, filed on Jun. 29, 2012, and Korean Patent Application No. 10-2013-0066740, filed on Jun. 11, 2013, in the Korean Intellectual Property Office, the disclosures of which are incorporated herein by reference.

### BACKGROUND

1. Field of the Invention

Exemplary embodiments relate to a cloud base station in a fixed-mobile converged access network and an operation method thereof, and more particularly, to a base station architecture for implementing a function of a physical layer (PHY) in a digital unit (DU) and a radio unit (RU) dissimilar to a legacy DU-RU separate-type base station architecture where a function of a PHY is only performed in a DU, and an operation method thereof.

2. Description of the Related Art

Each year, fixed-mobile access data traffic continues to increase by an approximate factor of two due to a substantially rapid increase of a mobile data service, and a dramatic increase in a number of wired broadband Internet service subscribers.

Accordingly, wired and wireless communication service providers are making an effort to deploy a fixed-mobile converged access network infrastructure at a reduced cost.

In the fixed-mobile converged access network, a fixed-mobile converged access network based on a common public radio interface (CPRI)/open base station architecture initiatives (OBSAI) supporting a digital unit (DU)-radio unit (RU) separate-type base station architecture increases a cost of optical and electrical components required to build a network due to an increase in an operable wired bandwidth.

Accordingly, there is a demand for an apparatus and method for providing low-cost and efficient transmission bandwidth with reduced infrastructure construction costs.

### SUMMARY

An aspect of the present invention provides a cloud base station with cost efficiency for implementing a function of a physical (PHY) layer in a digital unit (DU) and a radio unit (RU) dissimilar to a legacy DU-RU separate-type base station architecture in which a function of a PHY is only performed by a DU.

Another aspect of the present invention also provides an apparatus and method for transmitting and receiving a signal in a lower transmission bandwidth than that of a traditional technology by implementing communication channel using a subcarrier group allocated differently based on a combination of DU-RU.

Still another aspect of the present invention also provides an apparatus and method for long-distance signal transmission method with reduced costs associated with a PHY by transmitting and receiving information received via a plurality of radio channel links via only one optical link.

According to an aspect of the present invention, there is provided a cloud radio base station including a PHY layer unit to perform a quadrature amplitude modulation (QAM) of a parallel signal received from a media access control (MAC) layer per subcarrier, and an optical orthogonal frequency division multiplexing (OFDM) transceiver to transform the QAM modulated subcarriers into a time domain to generate an OFDM sample per subcarrier, add a cyclic prefix (CP) and control information for operating an enhanced radio unit (eRU) to the OFDM sample per subcarrier to generate a downstream signal, and transmit the downstream signal.

The PHY layer may include a QAM modulator to perform a QAM modulation of the parallel signal using a modulation scheme per subcarrier based on information received from the MAC layer, and a symbol adder to add training symbols for symbol synchronization and channel estimation to the QAM modulated OFDM subcarriers, and transmit the QAM modulated subcarriers with the added training symbols to the optical OFDM transceiver.

The optical OFDM transceiver may include an inverse fast Fourier transform (IFFT) processor to perform an IFFT on the QAM modulated subcarriers of a frequency domain to output a time-domain OFDM sample per subcarrier, and an information adder to add a CP to and control information for operating an eRU to the OFDM sample per subcarrier.

The subcarrier may be allocated flexibly to an eRU receiving the OFDM sample per subcarrier.

According to another aspect of the present invention, there is provided a cloud radio base station including an optical OFDM receiver to perform a frequency transformation of a downstream signal received from an eDU per subcarrier, to perform a time synchronization, and to perform a channel estimation, a PHY layer unit to perform an IFFT operation on the received signal, and a RF transceiver to transmit the signal on which the IFFT is performed to a subscriber's terminal over a certain carrier frequency corresponding to a conventional mobile communication service.

The optical OFDM receiver may include a frequency shifter to perform a frequency shift of the downstream signal received from the eDU per subcarrier, a time synchronizer to perform a time synchronization of the frequency shifted OFDM signal, and a channel estimator to perform a channel estimation of the time synchronized signal per subcarrier.

The frequency shifter may identify a carrier frequency pre-allocated for frequency shift using control information, and may perform a frequency shift in a preset particular frequency band by employing a voltage controlled oscillator (VCO).

The optical OFDM receiver may further include a analog to digital converter to convert the frequency shifted OFDM signal using a particular sampling frequency to a digital signal, and the time synchronizer may perform a time synchronization of the converted digital signal at a any starting point of a time-domain OFDM sample.

The optical OFDM receiver may further include a fast Fourier transform (FFT) processor to perform an FFT operation on the time synchronized OFDM signal and provide the signal on which the FFT is performed to the channel estimator, and a resource mapper to detect control information in the channel estimated signal and perform an FFT-IFFT symbol mapping for wireless transmission of OFDM symbols.

The resource mapper may change FFT/IFFT size, may perform a size matching operation, and may perform an operation processing of the symbol mapped signal, to allow concurrent transmission of in-phase (I)-channel and quadrature (Q)-channel information for a wireless transmission of the OFDM signal.

The resource mapper may handle frame control information for operating the eRU to an OFDM frame, and may transmit the OFDM frame to the eRU.

According to still another aspect of the present invention, there is provided a radio base station in a fixed-mobile converged access network, the radio base station including a PHY layer unit to transform a parallel signal received from a MAC layer into QAM modulated subcarriers in a time domain to generate a OFDM signal per subcarrier, and add a CP to the OFDM signal per subcarrier to generate a downstream signal, and an optical OFDM transceiver to perform an electric/optic conversion of the downstream signal and transmit the signal to the eRU.

The PHY layer may include a QAM modulator to perform a QAM modulation of the parallel signal using a QAM modulation scheme per subcarrier based on information received from the MAC layer, a symbol adder to add training symbols for symbol synchronization and channel estimation to the QAM modulated subcarriers, and transmit the QAM modulated subcarriers with the added training symbols to the optical OFDM transceiver, an IFFT processor to perform an IFFT operation on the QAM modulated subcarriers of a frequency domain to generate a time-domain OFDM sample per subcarrier, and an information adder to add a CP to the OFDM signal per subcarrier to compensate for a signal distortion caused by a time delay and a chromatic dispersion of an optical fiber.

According to yet another aspect of the present invention, there is provided a radio base station in a fixed-mobile converged access network, the radio base station including a frequency shifter to perform a frequency shift of a downstream signal received from an eDU per subcarrier, a time synchronizer to perform a time synchronization of the frequency shifted OFDM signal, an FFT processor to perform an FFT operation on the time synchronized OFDM signal, a channel estimator to perform a channel estimation of the signal, on which the FFT is performed, per subcarrier, a resource mapper to change an FFT size, an IFFT size, and a transmission rate of modulated signal per subcarrier based on an effective transmission bandwidth used in a wireless transmission section and a wired transmission section, a PHY layer unit to perform an IFFT operation on the OFDM signal for which the FFT size, the IFFT size, and the transmission data rate of modulated OFDM signal per subcarrier are changed, and a RF transceiver to transmit the signal on which the IFFT is performed to a subscriber's terminal over a certain carrier frequency corresponding to a traditional mobile communication service.

The resource mapper may parallelize OFDM symbols carried on one subcarrier for the wired section to N symbols to occupy N subcarriers for the wireless section.

The resource mapper may extract N symbols in a signal generated from N subcarriers for the wireless section, and may serialize the extracted signal.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a cloud base station according to an exemplary embodiment;

FIG. 2 is a diagram illustrating a structure of a cloud base station according to an exemplary embodiment;

FIG. 3 is a diagram illustrating an example of subcarrier allocation based on a combination of an enhanced digital unit and an enhanced radio unit (eDU-eRU) according to an exemplary embodiment;

FIG. 4 is a diagram illustrating a physical (PHY) layer unit according to an exemplary embodiment;

FIG. 5 is a diagram illustrating an optical orthogonal frequency division multiplexing (OFDM) transmitter according to an exemplary embodiment;

FIG. 6 is a diagram illustrating an example of an eDU according to an exemplary embodiment;

FIG. 7 is a diagram illustrating an optical OFDM receiver according to an exemplary embodiment;

FIG. 8 is a diagram illustrating an example of an eRU according to an exemplary embodiment;

FIG. 9 is a diagram illustrating an example of a resource mapper according to an exemplary embodiment;

FIG. 10 is a diagram illustrating a cloud base station in a fixed-mobile converged access network according to an exemplary embodiment;

FIG. 11 is a diagram illustrating a structure for operating a cloud base station in a fixed-mobile converged access network according to an exemplary embodiment;

FIG. 12 is a diagram illustrating subcarrier allocation based on a service type according to an exemplary embodiment;

FIG. 13 is a diagram illustrating a PHY layer unit according to an exemplary embodiment;

FIG. 14 is a diagram illustrating an example of an eDU according to an exemplary embodiment;

FIG. 15 is a diagram illustrating an optical OFDM transceiver according to an exemplary embodiment;

FIG. 16 is a diagram illustrating an example of an eRU according to an exemplary embodiment;

FIG. 17 is a diagram illustrating an example of a resource mapper according to an exemplary embodiment;

FIG. 18 is a diagram illustrating a de/framer according to an exemplary embodiment;

FIG. 19 is a diagram illustrating an operation of a deframer according to an exemplary embodiment;

FIG. 20 is a flowchart illustrating a method of operating an eDU of a cloud base station according to an exemplary embodiment;

FIG. 21 is a flowchart illustrating a method of operating an eRU of a cloud base station according to an exemplary embodiment;

FIG. 22 is a flowchart illustrating a method of operating an eDU in a fixed-mobile converged access network according to an exemplary embodiment; and

FIG. 23 is a flowchart illustrating a method of operating an eRU in a fixed-mobile converged access network according to an exemplary embodiment.

### DETAILED DESCRIPTION

Hereinafter, exemplary embodiments are described in detail with reference to the accompanying drawings. A communication method according to an exemplary embodiment may be performed by a cloud base station.

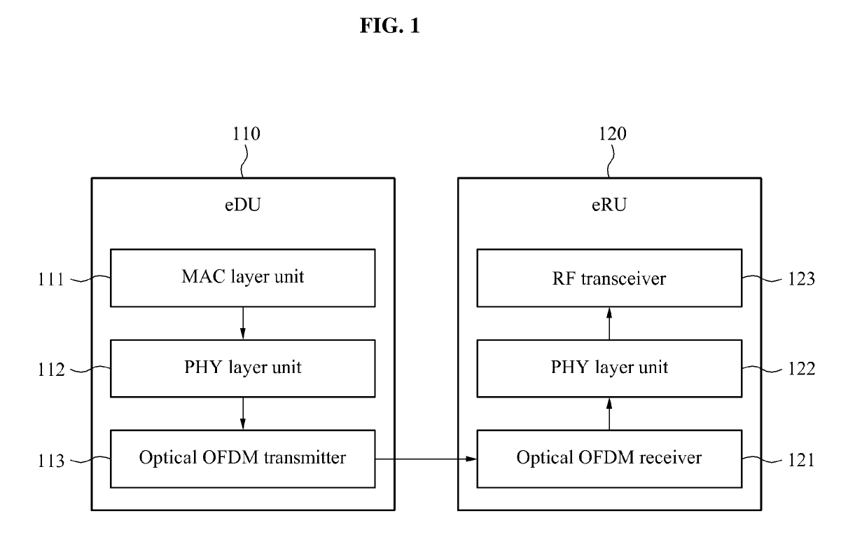

FIG. 1 is a diagram illustrating a cloud base station according to an exemplary embodiment.

The cloud base station according to an exemplary embodiment may correspond to a cloud base station supported by a fixed-mobile converged access network based on a common public radio interface (CPRI)/open base station architecture initiatives (OBSAI). Also, the cloud base station according to an exemplary embodiment may be used in a fixed-mobile converged access network, an orthogonal frequency division multiplexing (OFDM)-based fixed access network, an OFDM-based mobile access network, a CPRI/OBSAI-based mobile front-haul/back-haul transmission network, and an OFDM-based network.

Referring to FIG. 1, the cloud base station according to an exemplary embodiment may include an enhanced digital unit (eDU) 110 and an enhanced radio unit (eRU) 120.

The eDU 110 may include a media access control (MAC) layer unit 111, a physical (PHY) layer unit 112, and an optical OFDM transmitter 113.

The MAC layer unit 111 may include a MAC layer, and receive parallel-processed information from a wireless MAC. Also, the MAC layer unit 111 may transmit a parallel signal to the PHY layer unit 112.

For example, the MAC layer unit 111 may correspond to an OFDM specific MAC layer or a wireless MAC layer.

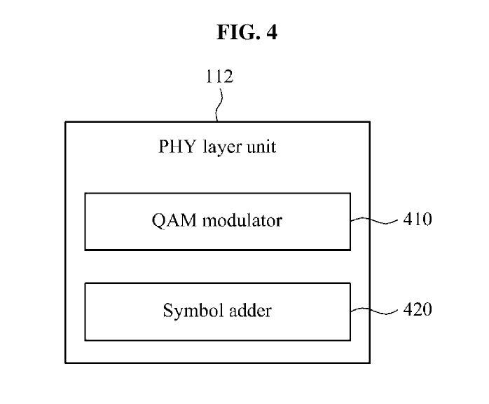

The PHY layer unit 112 may perform a quadrature amplitude modulation (QAM) of the parallel signal received from the MAC layer unit 111 for each subcarrier. A detailed configuration and an operation of the PHY layer unit 112 is described with reference to FIG. 4.

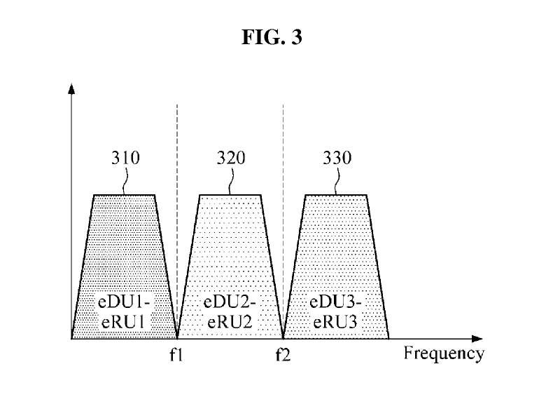

In this instance, different subcarriers may be used by the PHY layer unit 112 based on a combination of the eDU 110 and the eRU 120. A detailed description of subcarriers based on a combination of the eDU 110 and the eRU 120 is provided with reference to FIG. 3.

For example, the PHY layer unit 112 may correspond to an OFDM specific PHY layer (A block) or a wireless PHY (OFDM) layer-A.

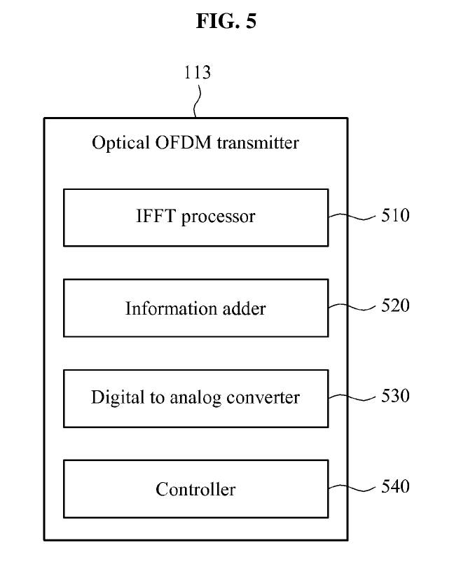

The optical OFDM transmitter 113 may transform the QAM modulated subcarriers by the PHY layer unit 112 into a time domain signal to generate an OFDM sample per subcarrier, add a cyclic prefix (CP) and control information for eRU operation to the OFDM sample per subcarrier to generate a downstream signal, and transmit the downstream signal. A detailed configuration and an operation of the optical OFDM transmitter 113 is described with reference to FIG. 5.

For example, the optical OFDM transmitter 113 may correspond to an OFDM to baseband transceiver for an eDU and an optical transceiver with OFDM scheme.

The eRU 120 may include an optical OFDM receiver 121, a PHY layer unit 122, and a RF transceiver 123.

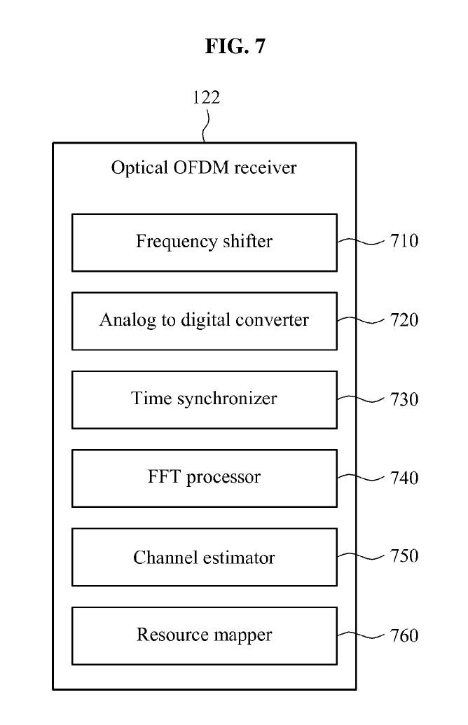

The optical OFDM receiver 121 may perform a frequency shift of the downstream signal received from the optical OFDM transmitter 113 of the eDU 110 for each subcarrier, perform a timing synchronization, and perform a channel estimation. A detailed configuration and an operation of the optical OFDM receiver 121 is described with reference to FIG. 7.

For example, the optical OFDM receiver 121 may correspond to an OFDM baseband transceiver for an eRU and an optical transceiver with OFDM scheme.

The PHY layer unit 122 may perform an inverse fast Fourier transform (IFFT) operation on the channel estimated signal by the optical OFDM receiver 121, and transmit the signal on which the IFFT is performed to the RF transceiver 123. For example, the PHY layer unit 122 may correspond to an OFDM specific PHY layer (B block) or a wireless PHY (OFDM) layer-B.

The RF transceiver 123 may transmit the signal on which the IFFT is performed by the PHY layer unit 122 to a subscriber's terminal over a certain carrier frequency corresponding to a traditional mobile communication service. For example, the RF transceiver 123 may correspond to a conventional radio frequency (RF) transceiver.

In this instance, a wireless section may use an IFFT of a maximum size because in-phase/quadrature (I/Q) transmission is possible. In contrast, a wired section may disable I/Q transmission since amplitude modulation and direct detection scheme is used to implement an optical transceiver module at a low cost. Accordingly, the PHY layer unit 122 may have an increased FFT size for a wired section to be twice as large as an IFFT size for a wireless section.

Also, the RF transceiver 123 may include an analog to digital converter and a digital to analog converter. The RF transceiver 123 may convert the signal on which the IFFT is performed to an analog signal using the digital to analog converter, and transmit the analog signal to a subscriber's terminal over a certain carrier frequency. The RF transceiver 123 may convert an analog signal received from the subscriber's terminal to a digital signal using the analog to digital signal converter, and transmit the digital signal to the PHY layer unit 122.

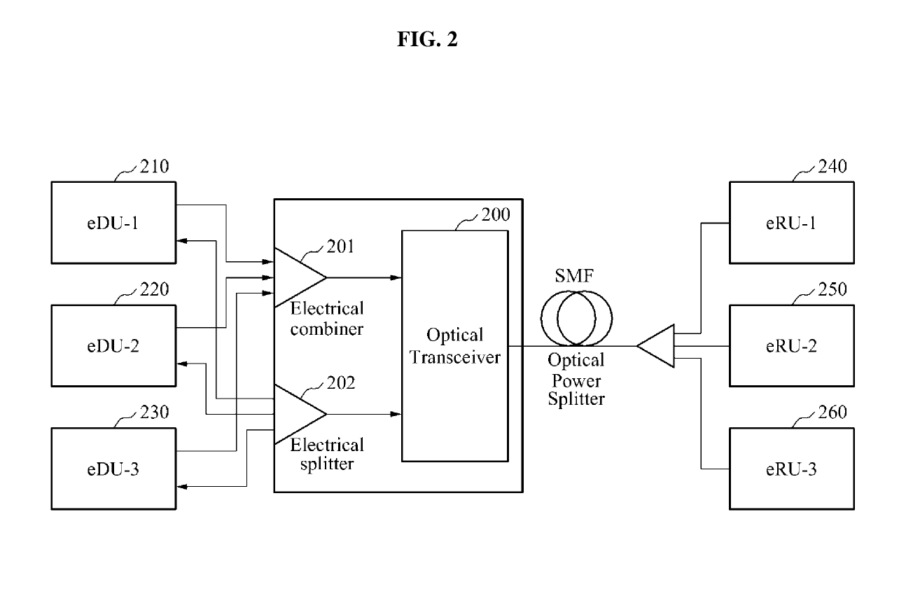

FIG. 2 is a diagram illustrating a structure of a cloud base station according to an exemplary embodiment.

Referring to FIG. 2, the cloud base station according to an exemplary embodiment may transmit a signal using an OFDM transmission scheme, and include a plurality of eDUs and a plurality of eRUs. In this instance, the eDUs may correspond to the eRUs in a one-to-one relationship to form one group.

For example, an eDU-1 210 may correspond to an eRU-1 240, and transmit and receive a signal including data to and from the eRU-1 240 using a particular frequency range. An eDU-2 220 may correspond to an eRU-2 250, and transmit and receive a signal including data to and from the eRU-2 250 using a particular frequency range. An eDU-3 230 may correspond to an eRU-3 260, and transmit and receive a signal including data to and from the eRU-3 260 using a particular frequency range. In this instance, the particular frequency range used by the eDU-1 210, the particular frequency range used by the eDU-2 220, and the particular frequency range used by the eDU-3 230 may differ.

In this instance, an optical transceiver 200 may perform an electric/optic conversion of an analog signal received from the eDU-1 210, the eDU-2 220, and the eDU-3 230 through an electrical combiner 201 to generate a downstream signal. Also, the optical transceiver 200 may transmit the generated downstream signal to an eRU corresponding to an eDU. For example, the optical transceiver 200 may transmit a downstream signal generated by performing an electric/optic conversion of an analog signal received from the eDU-1 210 to the eRU-1 240 corresponding to the eDU-1 210.

Also, the optical transceiver 200 may convert an optical signal received from the eRU-1 240, the eRU-2 250, and the eRU-3 260 to an analog signal, and transmit the analog signal to the eDU-1 210, the eDU-2 220, and the eDU-3 230 through an electrical splitter 202.

FIG. 3 is a diagram illustrating an example of subcarrier allocation based on a combination of eDU-eRU according to an exemplary embodiment.

Referring to FIG. 3, a cloud base station according to an exemplary embodiment may allocate a frequency range to be used by an eDU and an eRU based on a combination of eDU-eRU.

For example, the cloud base station may allocate a frequency range 310 lower than a frequency f1 to eDU1-eRU1 generated by matching the eDU-1 210 with the eRU-1 240. In this instance, the eDU-1 210 may transmit and receive a signal including data to and from the eRU-1 240 using the frequency range 310. More particularly, the eDU-1 210 may perform a QAM modulation of a parallel signal for each subcarrier included in the frequency range 310, transform the QAM modulated signal into a time domain to generate an OFDM sample per subcarrier, and provide the generated OFDM sample per subcarrier. Also, the eRU-1 240 may receive a signal obtained by performing an electric/optic conversion of the OFDM sample per subcarrier, and process and transmit the received signal in a wireless channel to a subscriber's terminal.

Also, the cloud base station may allocate a frequency range 320 between the frequency f1 and a frequency f2 to eDU2-eRU2 generated by matching the eDU-2 220 with the eRU-2 250, and a frequency range 330 greater than the frequency f2 to eDU3-eRU3 generated by matching the eDU-3 230 with the eRU-3 260.

Accordingly, the cloud base station may allocate a frequency range to be used for an eDU and an eRU to transmit and receive a signal differently based on a combination of eDU-eRU, to enable an optical transceiver to convert a signal received from a plurality of eDUs or eRUs without interference.

FIG. 4 is a diagram illustrating the PHY layer unit 112 according to an exemplary embodiment.

Referring to FIG. 4, the PHY layer unit 112 may include a QAM modulator 410 and a symbol adder 420.

The QAM modulator 410 may perform a QAM modulation of the parallel signal received from the MAC layer of the MAC layer unit 111.

In this instance, the QAM modulator 410 may receive information associated with a modulation scheme for each subcarrier from the MAC layer unit 111, perform a QAM modulation of the parallel signal using a specific modulation scheme for each subcarrier based on the received information, and generate the QAM modulated subcarriers.

The symbol adder 420 may add training symbols for symbol synchronization and channel estimation to the QAM modulated subcarriers, and transmit the QAM modulated subcarriers with the added training symbols to the optical OFDM transmitter 113.

FIG. 5 is a diagram illustrating the optical OFDM transmitter 113 according to an exemplary embodiment.

Referring to FIG. 5, the optical OFDM transmitter 113 may include an IFFT processor 510, an information adder 520, a digital to analog converter 530, and a controller 540.

The IFFT processor 510 may perform an IFFT operation on the subcarriers of a frequency domain on which the QAM modulation is performed by the PHY layer unit 112, and generate a time-domain OFDM sample per subcarrier.

The information adder 520 may add a CP and a control information for eRU operation to the OFDM sample per subcarrier output from the IFFT processor 510.

In this instance, the information adder 520 may add the CP to the OFDM sample per subcarrier to avoid the time delay induced inter symbol interference and distortion caused by chromatic dispersion on the downstream signal transmitted from the eDU110.

For example, the information adder 520 may convert the control information for an eRU operation in a form of a bitstream or a binary phase shift keying (BPSK) symbol, and add the control information to the OFDM sample per subcarrier.

The digital to analog converter 530 may convert, to an analog signal, the OFDM sample per subcarrier with the CP and control information for eRU operation added by the information adder 520, and may transmit the analog signal to the optical transceiver.

The controller 540 may select and handle the control information to be added to the OFDM sample per subcarrier by the information adder 520.

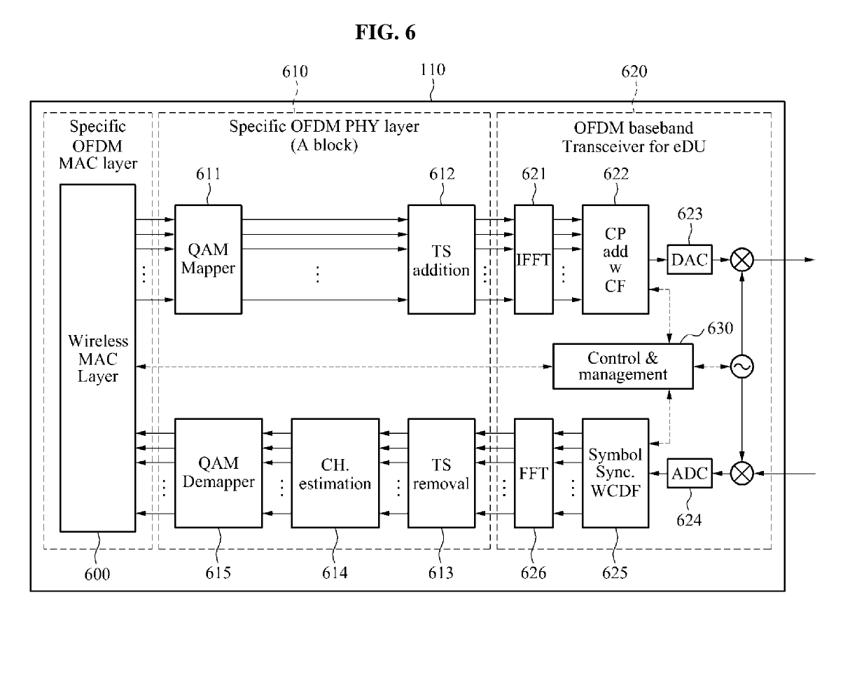

FIG. 6 is a diagram illustrating an example of the eDU 110 according to an exemplary embodiment.

1) A MAC layer 600 of the eDU 110 may generate a parallel signal to a specific OFDM PHY layer (A block) 610.

2) A QAM mapper 611 of the specific OFDM PHY layer (A block) 610 may perform a QAM modulation of the parallel signal output in 1) for each subcarrier. In this instance, the QAM mapper 611 may correspond to a QAM modulator 410 of FIG. 4.

3) A TS addition 612 of the specific OFDM PHY layer (A block) 610 may add training symbols for symbol synchronization and channel estimation to the QAM modulated subcarriers in 2), and provide the symbol added subcarriers to an OFDM baseband transceiver for eDU 620. In this instance, the TS addition 612 may correspond to the symbol adder 420 of FIG. 4.

4) An IFFT 621 of the OFDM baseband transceiver for eDU 620 may perform an IFFT on the frequency-domain subcarriers having the symbols added in 3) to generate a time-domain OFDM sample. In this instance, the IFFT 621 may correspond to the IFFT processor 510 of FIG. 5.

5) A CP add w control frame (CF) 622 of the OFDM baseband transceiver for eDU 620 may add a CP and control information for eRU operation to the time-domain OFDM sample per subcarrier output in 4). In this instance, the CP add w CF 622 may correspond to the information adder 520 of FIG. 5.

Also, the CP and the control information for eRU operation added to the time-domain OFDM sample per subcarrier by the CP add w CF 622 may correspond to information received from a controller 630.

6) A digital-to-analog converter (DAC) 623 of the OFDM baseband transceiver for eDU 620 may convert the OFDM sample per subcarrier with the added CP and control information for eRU operation to an analog signal, and transmit the analog signal to an optical transceiver. In this instance, the optical transceiver may perform an electric/optic conversion of the analog signal and transmit the signal to an eRU. Also, the DAC 623 may correspond to the digital to analog converter 530 of FIG. 5.

7) When the optical transceiver converts an upstream signal received from the eRU to an analog signal and transmits the analog signal to the OFDM baseband transceiver for eDU 620, an analog-to-digital converter (ADC) 624 may convert the received analog signal to a digital signal, and transmit the digital signal to a symbol sync. with control information deframer (WCDF) 625.

8) The symbol sync. WCDF 625 may synchronize the digital signal received in 7) and transmit the synchronized digital signal to an FFT 626.

9) The FFT 626 may perform an FFT on the digital signal synchronized in 8) to generate a frequency-domain OFDM sample per subcarrier.

10) A TS removal 613 may remove the training symbols for symbol synchronization and channel estimation from the frequency-domain OFDM sample per subcarrier output in 9).

11) A CH estimation 614 may perform a channel estimation for each channel of the OFDM sample per subcarrier from which the training symbols are removed in 10).

12) A QAM demapper 615 may perform a QAM demodulation of the OFDM sample per subcarrier for each subcarrier based on a result of the channel estimation in 11). In this instance, the QAM demapper 615 may transmit the QAM demodulated OFDM sample per subcarrier to the MAC layer 600.

FIG. 7 is a diagram illustrating the optical OFDM receiver 121 according to an exemplary embodiment.

Referring to FIG. 7, the optical OFDM receiver 121 may include a frequency shifter 710, an analog to digital converter 720, a time synchronizer 730, an FFT processor 740, a channel estimator 750, and a resource mapper 760.

The frequency shifter 710 may perform a frequency shift of the downstream signal received from the eDU 110 into a pre-defined particular frequency for each subcarrier.

The frequency shifter 710 may identify a carrier frequency allocated to the eRU 120 for frequency shift using control information because the eRU 120 uses a particular frequency band based on a combination with the eDU 110. Also, the frequency shifter 710 may implement a frequency shift in a pre-defined particular frequency band by employing a voltage controlled oscillator (VCO).

The analog to digital converter 720 may convert, to a digital signal, the analog signal transformed by the frequency shifter 710 using the particular sampling frequency.

The time synchronizer 730 may perform a timing synchronization of the digital signal converted by the digital converter 720. In this instance, the time synchronizer 730 may perform a timing synchronization of the digital signal at a starting point of the time-domain OFDM sample. For example, the time synchronizer 730 may correspond to the symbol sync. WCDF 625 of FIG. 6.

The FFT processor 740 may perform an FFT operation on the signal synchronized by the time synchronizer 730, and may provide the signal on which the FFT is performed to the channel estimator 750.

The channel estimator 750 may perform a channel estimation of the signal, on which the FFT is performed, for each subcarrier. In this instance, the channel estimator 750 may to perform a channel estimation of the signal on which the FFT is performed for each subcarrier to compensate for a distortion occurring with respect to the OFDM symbol for each subcarrier during transmitting of the downstream signal through an optical fiber.

The resource mapper 760 may detect control information in the channel estimated signal by the channel estimator 750, and perform an FFT-IFFT symbol mapping for wireless channel transmission of OFDM symbols.

In this instance, the resource mapper 760 may change FFT/IFFT sizes, and perform a matching, and a symbol mapping to allow concurrent transmission of I-channel and Q-channel information for a wireless section.

Also, the resource mapper 760 may detect and analyze control information generated by the eDU 110 and formed to an OFDM frame in the channel estimated signal. For example, the resource mapper 760 may separate and detect, using a deframer, control information present in the OFDM frame from the OFDM sample.

Also, the resource mapper 760 may frame control information for operating the eRU 120 to an OFDM frame, and transmit the OFDM frame to the eDU 110. For example, the resource mapper 760 may form an OFDM frame by inserting control information in a binary bitstream into an OFDM sample using a control framer. In this instance, the control information for operating the eRU may include at least one of data synchronization, frequency synchronization required for operating an antenna and a VCO, and automatic gain control information of an RF amplifier operating the antenna.

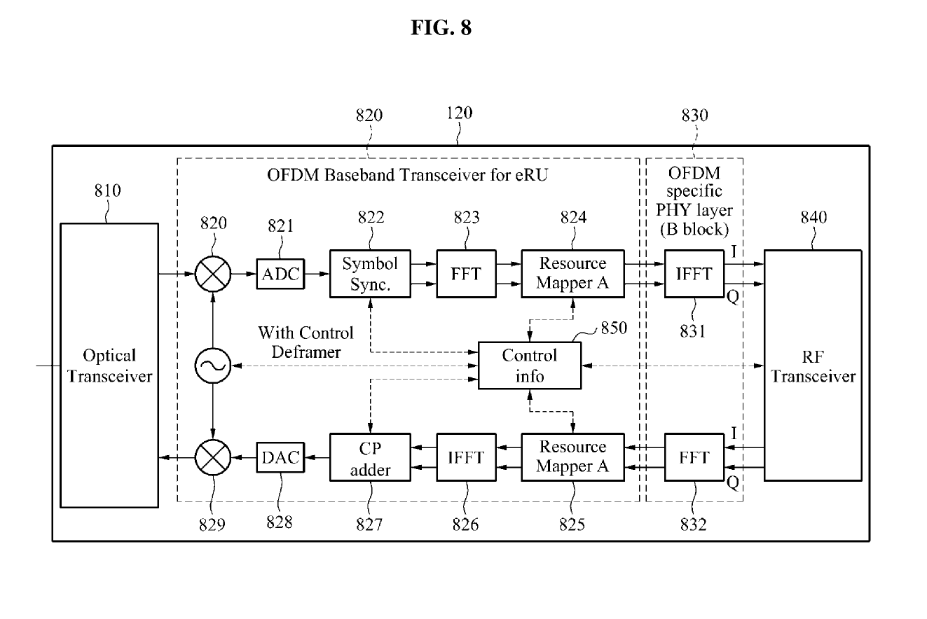

FIG. 8 is a diagram illustrating an example of the eRU 120 according to an exemplary embodiment.

1) An optical transceiver 810 of the eRU 120 may receive, from the optical transceiver of the eDU 110, the downstream signal transmitted from the eDU 110. In this instance, the optical transceiver 810 may perform an electric/optic conversion of the received downstream signal to provide an analog signal.

2) A frequency shifter 820 of an OFDM baseband transceiver for eRU 820 may perform a frequency shift of the signal output in 1).

3) An ADC 821 may convert the signal on which the frequency shift is performed in 2) to a digital signal using a particular sampling frequency.

4) A symbol sync. 822 may perform a timing synchronization of the digital signal converted in 3). In this instance, the symbol sync. 822 may perform a timing synchronization of the digital signal at a starting point of the time-domain OFDM sample.

5) An FFT 823 may perform an FFT operation on the signal on which the time synchronization is performed in 4). In this instance, the channel estimator 750 may perform a channel estimation of the signal on which the FFT is performed for each subcarrier to compensate for a distortion of the OFDM symbol for each subcarrier. Also, the channel estimator 750 may correspond to a separate component not shown in FIG. 8, perform a channel estimation on an output of the FFT 823, and transmit the channel estimated signal to a resource mapper A 824.

6) The resource mapper A 824 may detect control information in the signal on which the FFT is performed in 5), and perform an FFT-IFFT symbol mapping for wireless channel transmission of OFDM symbols.

In this instance, the resource mapper A 824 may change FFT/IFFT sizes, and perform a matching, and a symbol mapping to allow concurrent transmission of I-channel and Q-channel information for a wireless channel section.

Also, the resource mapper A 824 may detect and analyze control information generated by the eDU 110 and formed to an OFDM frame in the channel estimated signal.

7) An IFFT 831 of an OFDM specific PHY layer (B block) 830 may perform an IFFT on the signal on which the symbol mapping is performed in 6), and may transmit the signal on which the IFFT is performed to an RF transceiver 840.

8) The RF transceiver 840 may convert the signal on which the IFFT is performed to an analog signal using an digital to analog signal converter, and transmit the analog signal to a subscriber's terminal over a certain carrier frequency.

9) When the RF transceiver 840 receives an upstream signal from a user, the RF transceiver 840 may convert the upstream signal received from the user to a digital signal, and transmit the digital signal to an FFT 832 of the OFDM specific PHY layer (B block) 830.

10) The FFT 832 may perform an FFT operation on the upstream signal transmitted in 9).

11) A resource mapper A 825 may perform an FFT-IFFT symbol mapping of the upstream signal on which the FFT is performed in 10) for wired channel transmission of OFDM symbols, to generate an OFDM sample.

12) An IFFT 826 may perform an IFFT operation on the OFDM sample in an OFDM frame formed in 11), and provide the OFDM sample on which the IFFT is performed.

13) A CP adder 827 may form an OFDM frame by inserting control information for operating the eRU 120 provided from a control info 850 into the OFDM sample on which the IFFT is performed in 12).

14) A DAC 828 may convert the digital OFDM sample in the OFDM frame formed using an arbitrary sampling frequency in 13) to an analog signal.

15) A frequency shifter 829 may perform a frequency shift of the analog signal converted in 14).

16) The optical transceiver 810 may perform an electric/optic conversion of the analog signal on which the frequency shift is performed in 15), and transmit the signal to the eDU 110.

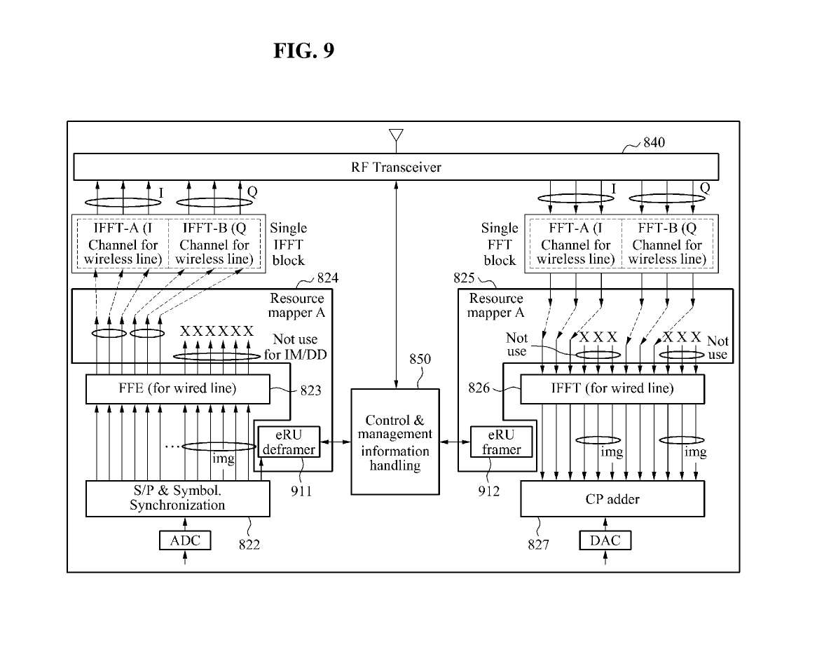

FIG. 9 is a diagram illustrating an example of the resource mapper according to an exemplary embodiment.

Referring to FIG. 9, the resource mapper A 824 may change FFT/IFFT sizes, and perform a matching, and a symbol mapping to allow concurrent transmission of I-channel and Q-channel information for a wireless section.

Also, the resource mapper A 824 may include an eRU deframer 911 to detect control information generated by the eDU 110 and framed to an OFDM frame.

The eRU deframer 911 may separate the control information present in the OFDM symbol from the OFDM sample as the signal on which the time synchronization is performed by the symbol sync. 822, and offer the control information to a control & management 850. In this instance, the control & management 850 may be identical to the control info 850 of FIG. 8.

Also, the resource mapper A 825 may provide the OFDM sample by changing FFT/IFFT sizes based on the I-channel and Q-channel information for the wireless channel section received from the RF transceiver 840, by performing a matching, and a symbol mapping.

In this instance, the resource mapper A 825 may include an eRU framer 912 to frame the control information. In this instance, the eRU framer 912 may form the OFDM frame by inserting the control information in a binary bitstream into the OFDM sample.

Also, the CP adder 827 may add the CP to the OFDM sample on which the IFFT is performed in 12) to avoid the time delay induced ISI and distortion caused by chromatic dispersion on the upstream signal transmitted from the eRU 120.

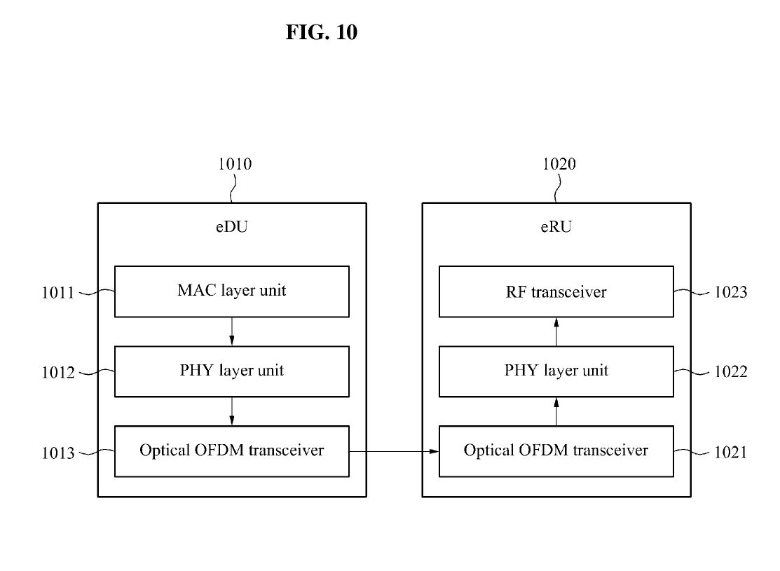

FIG. 10 is a diagram illustrating a cloud base station in a fixed-mobile converged access network according to an exemplary embodiment.

The cloud base station may use an OFDM transmission scheme having the best spectral efficiency. For example, use of a frequency division multiplexing (FDM)-subcarrier multiplexing (SCM) or wavelength division multiplexing (WDM) transmission scheme may be possible in an actual application, and a specific method of a transmission scheme is not limited thereby.

Referring to FIG. 10, the cloud base station according to an exemplary embodiment may include an eDU 1010 and an eRU 1020.

In this instance, the eDU 1010 may correspond to an optical line terminal (OLT), and the eRU 1020 may correspond to an optical network unit (ONU).

The eDU 1010 may include a MAC layer unit 1011, a PHY layer unit 1012, and an optical OFDM transceiver 1013.

The MAC layer unit 1011 may include a legacy passive optical network (PON) MAC or a wireless MAC layer. For example, the legacy PON MAC may correspond to a gigabit PON (GPON) or an Ethernet PON (EPON), and the wireless MAC may correspond to an eDU interface.

In this instance, the MAC layer unit 1011 may receive parallel processed information from the legacy PON MAC or the wireless MAC. Also, the MAC layer unit 1011 may transmit the parallel signal to the PHY layer unit 1012. For example, the MAC layer unit 1011 may correspond to an OFDM based MAC layer.

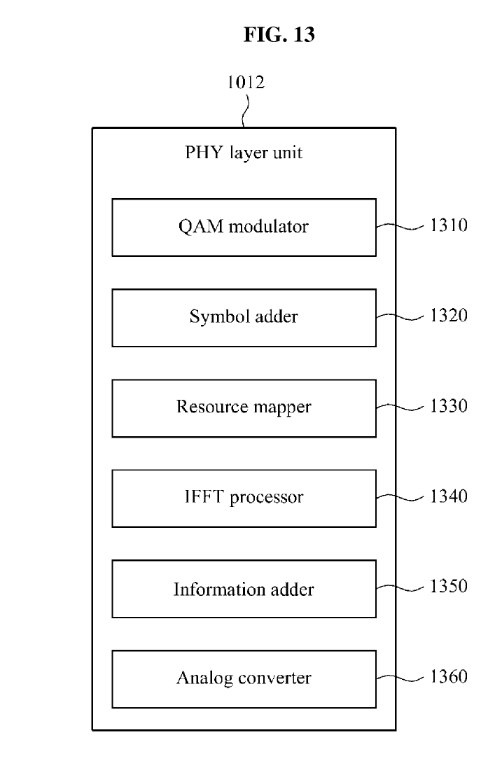

The PHY layer unit 1012 may perform a QAM modulation of the parallel signal received from the MAC layer unit 1011 for each subcarrier, transform the QAM modulated subcarriers into a time domain to generate an OFDM sample per subcarrier, add a CP and control information for eRU operation to the OFDM sample per subcarrier to generate a downstream signal, and transmit the downstream signal. A detailed configuration and an operation of the PHY layer unit 1012 is described with reference to FIG. 13.

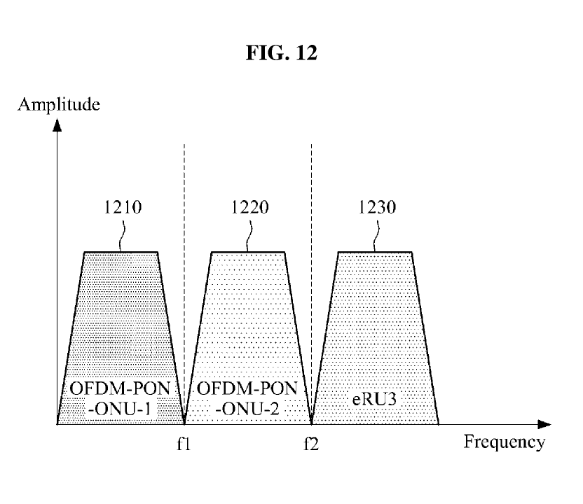

In this instance, different subcarriers may be used by the PHY layer unit 1012 based on a target to which the signal is to be transmitted from the eDU 1010. A further description of the subcarriers based on the target to which the signal is to be transmitted from the eDU 1010 is provided with reference to FIG. 12.

The optical OFDM transceiver 1013 may perform an electric/optic conversion of the downstream signal output from the PHY layer unit 1012, and transmit the signal to the eRU 1020 or an ONU. Also, when the eRU 1020 or ONU transmits an upstream signal, the optical OFDM transceiver 1013 may perform an electric/optic conversion of the received upstream signal, and transmit the signal to the PHY layer unit 1012. For example, the optical OFDM transceiver 1013 may correspond to a direct modulation-type optical transceiver.

The eRU 1020 may include an optical OFDM transceiver 1021, a PHY layer unit 1022, and a RF transceiver 1023.

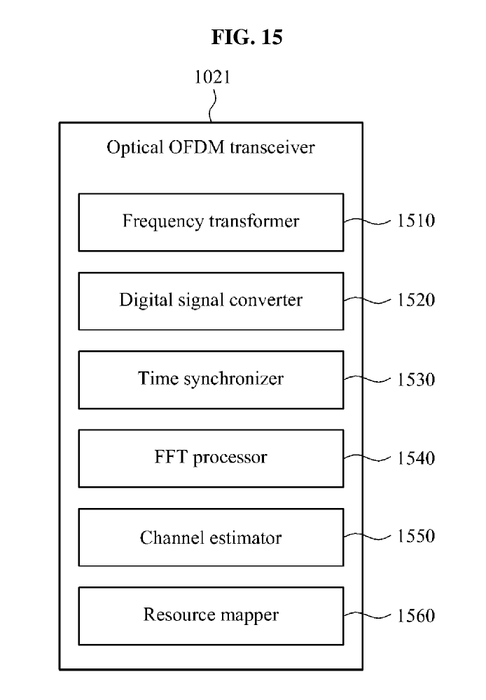

The optical OFDM transceiver 1021 may perform a frequency shift of the downstream signal received from the optical OFDM transceiver 1013 of the eDU 1010, perform a timing synchronization, and a channel estimation. A detailed configuration and an operation of the optical OFDM transceiver 1021 is described with reference to FIG. 15.

For example, the optical OFDM transceiver 1021 may correspond to an OFDM baseband transceiver for eRU or an optical transceiver with OFDM scheme.

The PHY layer unit 1022 may perform an IFFT operation on the signal on which the channel estimation is performed by the optical OFDM transceiver 1021, and transmit the signal on which the IFFT operation is performed to the RF transceiver 1023. For example, the PHY layer unit 1022 may correspond to an OFDM specific PHY layer (B block).

The RF transceiver 1023 may transmit the signal on which the IFFT is performed by the PHY layer unit 1022 to a subscriber terminal over a certain carrier frequency corresponding to a traditional mobile communication service.

In this instance, a wireless channel section may use an IFFT operation of a maximum size because I/Q transmission is possible. In contrast, a wired channel section may disable concurrent I/Q data transmission since amplitude modulation and direct detection scheme is used to implement an optical transceiver module at a low cost. Accordingly, the RF transceiver 1023 may have an increased FFT size for a wired section to be twice as large as an IFFT size for a wireless section.

Also, the RF transceiver 1023 may include a digital to analog converter and an analog to digital signal converter. The RF transceiver 1023 may convert the signal on which the IFFT operation is performed to an analog signal using the digital to analog converter, and transmit the analog signal to a subscriber's terminal over a certain carrier frequency. The RF transceiver 1023 may convert an analog signal received from the subscriber terminal to a digital signal using the analog to digital signal converter, and transmit the digital signal to the PHY layer unit 1022.

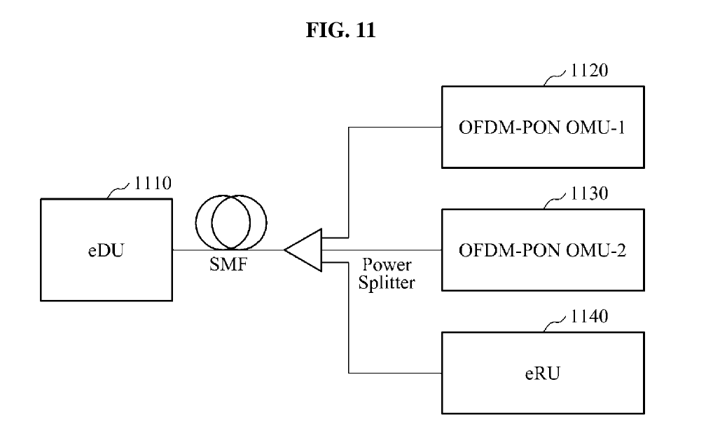

FIG. 11 is a diagram illustrating a structure for operating a cloud base station in a fixed-mobile converged access network according to an exemplary embodiment.

Referring to FIG. 11, the structure for operating the cloud base station in the fixed-mobile converged access network according to an exemplary embodiment may multiplex a signal generated from a legacy PON MAC corresponding to a wired service, to allow transmission of a plurality of TDM-PON MACs through a single OFDM PHY/MAC configuration. In this instance, a wired infrastructure used in FIG. 11 may correspond to PON based on OFDM signal transmission.

More particularly, an eDU 1110 may multiplex a signal received from a wired service, and transmit the signal to an OFDM-PON ONU-1 1120, an OFDM-PON ONU-2 1130, and an eRU 1140.

For example, the structure for operating the cloud base station in the fixed-mobile converged access network may reduce costs involving implementation/construction of a physical layer and allow long-distance transmission of 100 kilometers (km) or longer without compensating fiber chromatic dispersion, by multiplexing ‘n’ of GPON links with downstream 2.5 Gbps/upstream 1.25 Gbps transmission in a structure of a single OFDM PHY and a single optical link as shown in FIG. 11.

Also, the cloud base station according to an exemplary embodiment may use low-cost optical/RF components by exploiting an OFDM transmission scheme allowing spectrally-efficient transmission means, thereby reducing initial investment of costs. Further, the use of an OFDM transmission scheme may enable the cloud base station according to an exemplary embodiment to interwork with existing mobile communication network using an OFDM based transmission scheme. Accordingly, costs incurred in implementing a physical layer for front-haul transmission of a CPRI/OBSAI-based virtual cloud radio base station requiring a relatively wide transmission bandwidth may be reduced in an effective manner, and a single wired infrastructure may be shared and consequently, infrastructure construction costs may be reduced.

FIG. 12 is a diagram illustrating subcarrier allocation method dependent on a service type according to an exemplary embodiment.

Referring to FIG. 12, a cloud base station according to an exemplary embodiment may allocate a frequency range to be used for signal transmission from an eDU to a target.

For example, the cloud base station may allocate a frequency range 1210 lower than a frequency f1 to an OFDM-PON ONU-1, a frequency range between the frequency f1 and a frequency f2 to an OFDM-PON ONU-2, and a frequency range 1230 greater than the frequency f2 to an eDU3.

When a service to be provided corresponds to a service corresponding to the OFDM-PON ONU-1, an eDU may transmit and receive a signal including data to and from the OFDM-PON ONU-1 using the frequency range 1210.

Also, when the service to be provided corresponds to a service corresponding to the eDU3, the eDU may transmit and receive a signal including data to and from the eDU3 using the frequency range 1230.

FIG. 13 is a diagram illustrating the PHY layer unit 1012 according to an exemplary embodiment.

Referring to FIG. 13, the PHY layer unit 1012 may include a QAM modulator 1310, a symbol adder 1320, a resource mapper 1330, an IFFT processor 1340, an information adder 1350, and a digital to analog converter 1360.

The QAM modulator 1310 may perform a QAM modulation of the parallel signal received from the MAC layer unit 1011.

In this instance, the QAM modulator 1310 may receive information associated with a modulation scheme per subcarrier from the MAC layer unit 1011, and perform a QAM modulation of the parallel signal using a modulation scheme per subcarrier based on the received information to provide QAM modulated subcarriers.

The symbol adder 1320 may add training symbols for symbol synchronization and channel estimation to the QAM modulated subcarriers.

The resource mapper 1330 may change an FFT size, an IFFT size, and a transmission rate of modulated data per subcarrier for subcarriers or an upstream signal based on an effective transmission bandwidth used in a wireless section and a wired section. In this instance, the QAM modulator 1310 may perform a QAM modulation of the parallel signal received from the MAC layer to generate QAM modulated subcarriers, and the symbol adder 1320 may add training symbols to the QAM modulated subcarriers and transmit the QAM modulated subcarriers with the added training symbols to the resource mapper 1330.

The IFFT processor 1340 may perform an IFFT operation on the frequency-domain subcarriers with the training symbols added by the symbol adder 1320 and the subcarriers for which the FFT size, the IFFT size, and the transmission rate of modulated data per subcarrier are changed by the resource mapper 1330, to provide a time-domain OFDM sample.

The information adder 1350 may add a CP and control information for eRU operation to the OFDM sample per subcarrier output from the IFFT processor 1340.

In this instance, the information adder 1350 may add the CP to the OFDM sample per subcarrier to enable the eRU 1020 or ONU to compensate for a signal distortion caused by a time delay and a chromatic dispersion of an optical fiber.

For example, the information adder 1350 may convert the control information for eRU operation in a form of a bitstream or a BPSK symbol, and add the control information to the OFDM sample per subcarrier.

The digital to analog converter 1360 may convert the OFDM sample per subcarrier with the CP and control information for eRU operation added by the information adder 1350 to an analog signal, and transmit the analog signal to the optical transceiver 1013.

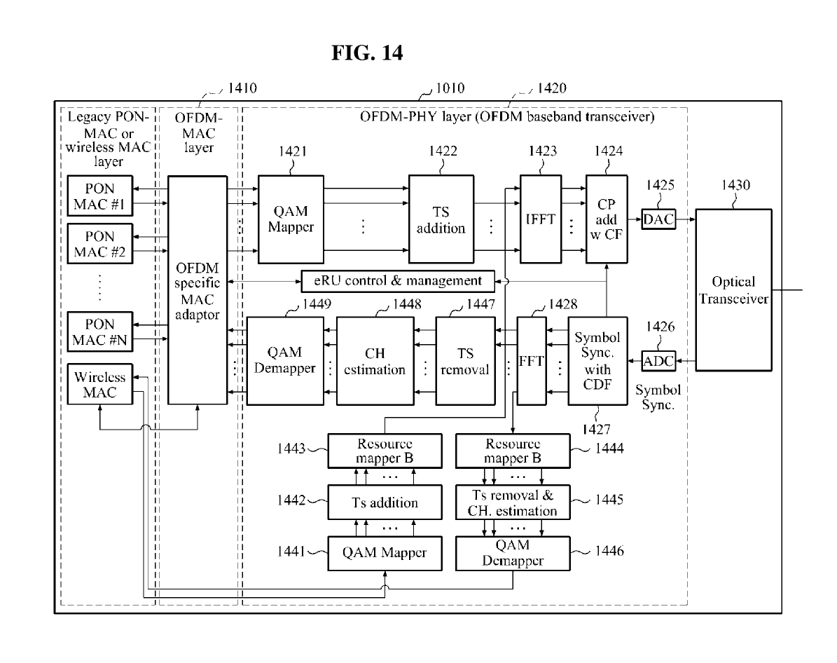

FIG. 14 is a diagram illustrating an example of the eDU 1010 according to an exemplary embodiment.

1) A MAC layer 1410 of the eDU 1010 may receive parallel processed information from a legacy PON MAC and wireless MAC, and provide a parallel signal based on the received information to an OFDM PHY layer 1420.

2) A QAM mapper 1421 of an OFDM PHY layer 1420 may perform a QAM modulation of the parallel signal output in 1) for each subcarrier. In this instance, the QAM mapper 1421 may correspond to the QAM modulator 1310 of FIG. 13.

3) A TS addition 1422 of the OFDM PHY layer 1420 may add training symbols for symbol timing synchronization and channel estimation to the subcarriers on which the QAM modulation is performed in 2). In this instance, the TS addition 1422 may correspond to the symbol adder 1320 of FIG. 13.

4) A QAM mapper 1441 may perform a QAM modulation of a parallel signal received from the MAC layer unit for each subcarrier.

5) A TS addition 1442 may add training symbols for symbol synchronization and channel estimation to the subcarriers on which the QAM modulation is performed in 4).

6) A resource mapper B 1443 may change an FFT size, an IFFT size, and a transmission rate of modulated data per subcarrier for the frequency-domain subcarriers with the symbols added in 5) based on an effective transmission bandwidth used in a wireless channel section and a wired channel section. In this instance, the resource mapper B 1443 may correspond to the resource mapper 1330 of FIG. 13.

7) An IFFT 1423 of the OFDM PHY layer 1420 may perform an IFFT operation on the frequency-domain subcarriers with the symbols added in 3) and the subcarriers for which the FFT size, the IFFT size, and the transmission rate of modulated data per subcarrier are changed in 6), to generate a time-domain OFDM sample per subcarrier. In this instance, the IFFT 1423 may correspond to the IFFT processor 1340 of FIG. 13.

8) A CP add w CF 1424 of the OFDM PHY layer 1420 may add a CP and control information for eRU operation to the time-domain OFDM sample per subcarrier output in 7). In this instance, the CP add w CF 1424 may correspond to the information adder 1350 of FIG. 13.

9) A DAC 1425 of the OFDM PHY layer 1420 may convert the OFDM sample per subcarrier with the CP and control information for eRU operation added in 8) to an analog signal, and transmit the analog signal to an optical transceiver 1430. In this instance, the DAC 1425 may correspond to a digital to analog converter 1360 of FIG. 13.

10) The optical transceiver 1430 may perform an electric/optic conversion of the analog signal received in 9) and transmit the signal to an eRU or ONU.

11) When the optical transceiver 1430 receives an upstream signal from the eRU or ONU, the optical transceiver 1430 may convert the received upstream signal to an analog signal, and provide the analog signal.

12) An ADC 1426 of the OFDM PHY layer 1420 may convert the analog signal received in 11) to a digital signal and transmit the digital signal to a symbol sync. WCDF 1427, and the symbol sync. WCDF 1427 may perform synchronize the received digital signal and transmit the synchronized digital signal to an FFT 1428.

13) An FFT 1428 may perform an FFT operation on the digital signal synchronized in 12) to provide a frequency-domain OFDM sample per subcarrier.

14) A TS removal 1447 may remove training symbols for symbol synchronization and channel estimation from the frequency-domain OFDM sample per subcarrier output in 13).

15) A CH estimation 1448 may perform a channel estimation for each channel of the OFDM sample per subcarrier from which the training symbols are removed in 14) to recover amplitude and phase information.

16) A QAM demapper 1449 may perform a QAM demodulation of the OFDM sample per subcarrier for each subcarrier based on a result of the evaluation in 15). In this instance, the QAM demapper 1449 may transmit the QAM demodulated OFDM sample per subcarrier to the MAC layer 1410.

17) A resource mapper B 1444 may change an FFT size, an IFFT size, and a transmission rate of modulated data per subcarrier for the frequency-domain OFDM sample per subcarrier output in 13) based on an effective transmission bandwidth used in a wireless channel section and a wired channel section.

18) A TS removal & CH estimation 1445 may remove the training symbols for symbol synchronization and channel estimation from the OFDM sample per subcarrier for which the FFT size, the IFFT size, and the transmission rate of modulated data per subcarrier are changed in 17), and perform a channel estimation for each channel of the OFDM sample per subcarrier to recover amplitude and phase information.

19) A QAM demapper 1446 may perform a QAM demodulation of the OFDM sample per subcarrier for each subcarrier based on a result of the evaluation in 18). In this instance, the QAM demapper 1446 may transmit the QAM demodulated OFDM sample per subcarrier to the MAC layer 1410.

FIG. 15 is a diagram illustrating the optical OFDM transceiver 1021 according to an exemplary embodiment.

Referring to FIG. 15, the optical OFDM transceiver 1021 may include a frequency shifter 1510, a digital signal converter 1520, a time synchronizer 1530, an FFT processor 1540, a channel estimator 1550, and a resource mapper 1560.

The frequency shifter 1510 may perform a frequency shift of the downstream signal to received from the eDU 110 for each subcarrier.

The frequency shifter 1510 may identify a carrier frequency allocated to the eRU 1020 for frequency shift using control information because the eRU 1020 uses a particular frequency band based on a combination with the eDU 1010. Also, the frequency shifter 1510 may perform a frequency shift in a pre-defined frequency band by employing a VCO.

The analog to digital converter 1520 may convert, to a digital signal, the signal on which the frequency shift is performed by the frequency shift 1510 using a particular sampling frequency.

The time synchronizer 1530 may perform a timing synchronization of the digital signal converted by the analog to digital converter 1520. In this instance, the time synchronizer 1530 may perform a timing synchronization of the digital signal at a starting point of the time-domain OFDM sample. The FFT processor 1540 may perform an FFT operation on the signal on which the timing synchronization is performed by the time synchronizer 1530, and provide the signal on which the FFT operation is performed to the channel estimator 1550.

The channel estimator 1550 may perform a channel estimation of the signal, on which the FFT operation is performed, for each subcarrier. In this instance, the channel estimator 1550 may perform a channel estimation of the signal, on which the FFT is performed, for each subcarrier to compensate for a distortion occurring to the OFDM symbol per subcarrier during transmitting the downstream signal through an optical fiber.

The resource mapper 1560 may change an FFT size, an IFFT size, and a transmission rate of modulated data per subcarrier based on an effective transmission bandwidth used in a wireless channel section and a wired channel section.

Also, the resource mapper 1560 may parallelize, to N symbols, OFDM symbols carried on one subcarrier for a wired channel section on which the channel estimation is performed by the channel estimator 1550, to occupy N subcarriers for a wireless channel section.

In this instance, the resource mapper 1560 may change FFT/IFFT sizes, and perform a matching, and a symbol mapping to allow concurrent transmission of I-channel and Q-channel information for the wireless section.

Also, the resource mapper 1560 may detect and analyze control information generated by the eDU 1010 and formed to an OFDM frame in the channel estimated signal. For example, the resource mapper 1560 may separate, using a deframer, control information present in the OFDM frame from the OFDM sample.

Also, the resource mapper 1560 may frame the control information for operating the eDU 1010 to an OFDM frame, and transmit the OFDM frame to the eDU 1010. For example, the resource mapper 1560 may form an OFDM frame by inserting the control information in a binary bitstream into an OFDM sample using a framer. In this instance, the control information for operating the eRU may include at least one of data synchronization, frequency synchronization required for operating an antenna and a VCO, and automatic gain control information of an RF amplifier operating the antenna.

In this instance, the PHY layer unit 1022 may perform an IFFT operation on the signal for which the FFT size, the IFFT size, and the transmission rate of modulated data per subcarrier are changed.

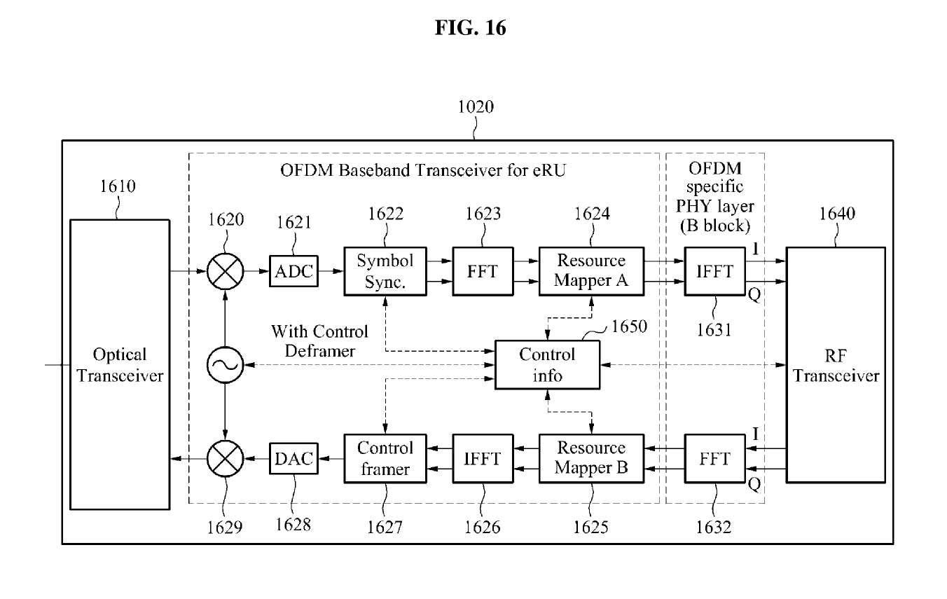

FIG. 16 is a diagram illustrating an example of the eRU 1020 according to an exemplary embodiment.

1) An optical transceiver 1610 of the eRU 1020 may receive, from the optical transceiver of the eDU 1010, the downstream signal transmitted from the eDU 1010. In this instance, the optical transceiver 1610 may perform an electri/optic conversion of the received downstream signal to provide an analog signal.

2) A frequency shifter 1620 of an OFDM baseband transceiver for eRU may perform a frequency shift of the signal output in 1).

3) An ADC 1621 may convert the signal on which the frequency shift is performed using a particular sampling frequency in 2) to a digital signal.

4) A symbol sync. 1622 may perform a timing synchronization of the digital signal converted in 3). In this instance, the symbol sync. 1622 may perform a timing synchronization of the digital signal at a starting point of the time-domain OFDM sample.

5) An FFT 1623 may perform an FFT operation on the signal on which the timing synchronization is performed in 4).

6) A resource mapper A 1624 may detect control information in the signal on which the FFT operation is performed in 5), and perform an FFT-IFFT symbol mapping for wireless channel transmission of OFDM symbols.

Also, the resource mapper A 1624 may parallelize OFDM symbols carried on one subcarrier for a wired section to N symbols to occupy N subcarriers for a wireless section.

Also, the resource mapper A 1624 may change FFT/IFFT sizes, and perform a matching, and a symbol mapping to allow concurrent transmission of I-channel and Q-channel information of a wireless section.

Also, the resource mapper A 1624 may detect and analyze control information generated by the eDU 1010 and formed to an OFDM frame in the channel estimated signal.

7) A resource mapper B 1624 may change an FFT size, an IFFT size, and a transmission rate of modulated data per subcarrier based on an effective transmission bandwidth used in a wireless section.

8) An IFFT 1631 of an OFDM specific PHY layer (B block) 1630 may perform an IFFT operation of the size changed in 7) on the signal on which the symbol mapping is performed in 6), and transmit the signal on which the IFFT operation is performed to an RF transceiver 1640.

9) The RF transceiver 1640 may convert the signal on which the IFFT operation is performed in 8) to an analog signal using a digital to analog converter, and transmit the to analog signal to a subscriber's terminal over a certain carrier frequency.

10) When the RF transceiver 1640 receives an upstream signal from a user, the RF transceiver 1640 may convert the upstream signal received from the user to a digital signal, and transmit the digital signal to an FFT 1632 of the OFDM specific PHY layer (B block) 1630.

11) The FFT 1632 may perform an FFT operation on the upstream signal transmitted in 10) to fit the size changed in 7).

12) A resource mapper B 1625 may perform an FFT-IFFT symbol mapping of the upstream signal on which the FFT operation is performed in 11) for wired channel transmission of OFDM symbols, to provide an OFDM sample. In this instance, the resource mapper B 1625 may serialize N symbols occupying N subcarriers for a wireless channel section on one subcarrier for a wired channel section.

13) The resource mapper B 1625 may change an FFT size, an IFFT size, and a transmission rate of modulated data per subcarrier based on an effective transmission bandwidth used in a wired channel section.

14) An IFFT 1626 may perform an IFFT operation of the size changed in 13) on the OFDM sample in an OFDM frame formed in 12), and generate the OFDM sample on which the IFFT operation is performed.

15) A control framer 1627 may form an OFDM frame by inserting control information for operating the eDU 1010 provided from a control info 1650 into the OFDM sample on which the IFFT is performed in 12).

16) A DAC 1628 may convert the OFDM sample in the OFDM frame formed using a particular sampling frequency in 15) to an analog signal.

17) A frequency shifter 1629 may transform the analog signal converted in 16) into a particular frequency for each subcarrier.

18) The optical transceiver 1610 may perform an electric/optic conversion of the analog signal on which the frequency shift is performed in 17), and transmit the signal to the eDU 1010.

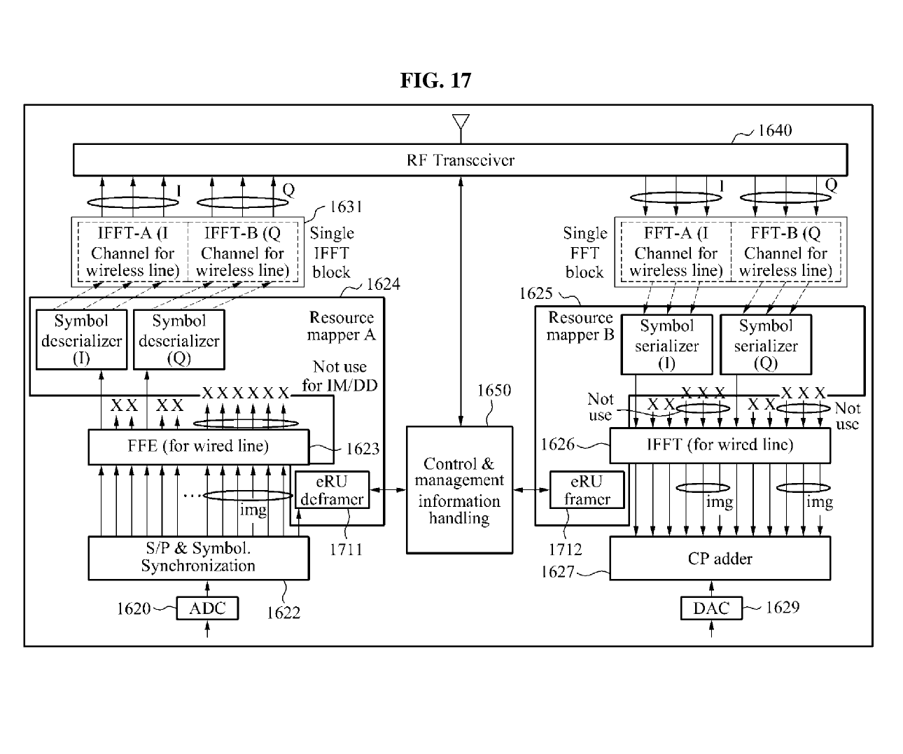

FIG. 17 is a diagram illustrating an example of the resource mapper according to an exemplary embodiment.

Referring to FIG. 17, the resource mapper A 1624 may change FFT/IFFT sizes, and perform a matching and a symbol mapping to allow concurrent transmission of I-channel and Q-channel information for a wireless channel section. In this instance, the resource mapper A 1624 may parallelize OFDM symbols carried on one subcarrier of a wired channel section to N symbols to occupy N subcarriers in a wireless channel section.

Also, the resource mapper A 1624 may include an eRU deframer 1711 to detect control information generated by the eDU 110 and framed to an OFDM frame.

The eRU deframer 1711 may separate control information present in an OFDM frame from an OFDM sample as a signal on which the timing synchronization is performed by the symbol sync. 1622, and transmit the control information to the control & management 1650. In this instance, the control & management 1650 may be identical to the control info 850 of FIG. 8.

Also, when the resource mapper B 1625 receives N subcarriers from the RF transceiver, the resource mapper B 1625 may extract N symbols from the received N subcarriers and serialize the extracted N symbols on one symbol to allow an IFFT for a wired channel section.

In this instance, the resource mapper B 1625 may include an eRU framer 1712 to form the control information for operating the eDU 1010 to an OFDM frame. In this instance, the eRU framer 1712 may form an OFDM frame by inserting the control information in a binary bitstream into the OFDM sample.

Also, the CP adder 1627 may be identical to the control framer 1627 of FIG. 16. In this instance, the CP adder 1627 may add a CP to the OFDM sample on which the IFFT operation is performed in 10) to avoid the time delay induced ISI and distortion caused by chromatic dispersion on the upstream signal transmitted from the eRU 1020.

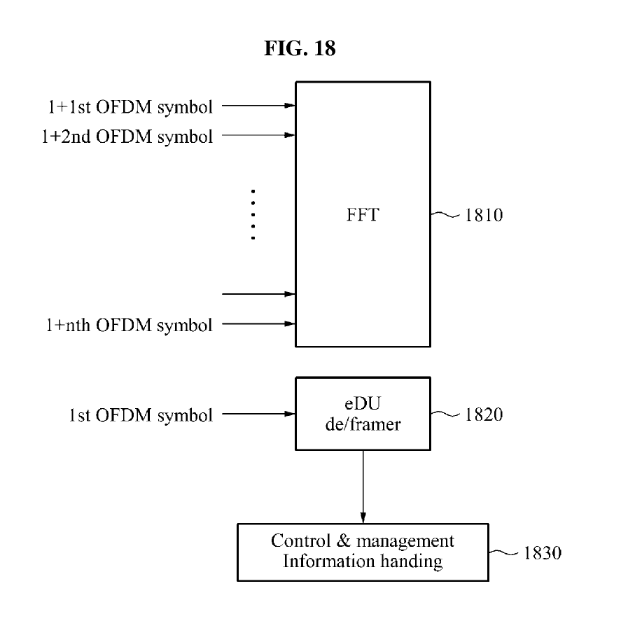

FIG. 18 is a diagram illustrating a de/framer 1820 according to an exemplary embodiment.

The de/framer 1820 included in an eDU and an eRU may extract a first OFDM symbol added similar to a preamble among OFDM symbols transmitted to an FFT 1810. Also, the de/framer 1820 may detect control information formed to an OFDM frame using the extracted OFDM symbol, and control the eDU and the eRU using the detected control information.

In this instance, the de/framer 1820 may work as a framer to form an OFDM frame by inserting control information into an OFDM symbol.

The de/framer 1820 included in the eDU and the eRU may generate a control symbol by symbolizing control information received from a control & management 1830 using a modulation scheme such as BPSK. Also, the de/framer 1820 may form an OFDM frame with a sequence of OFDM symbols by adding the generated control symbol before a start of OFDM symbols similar to a preamble.

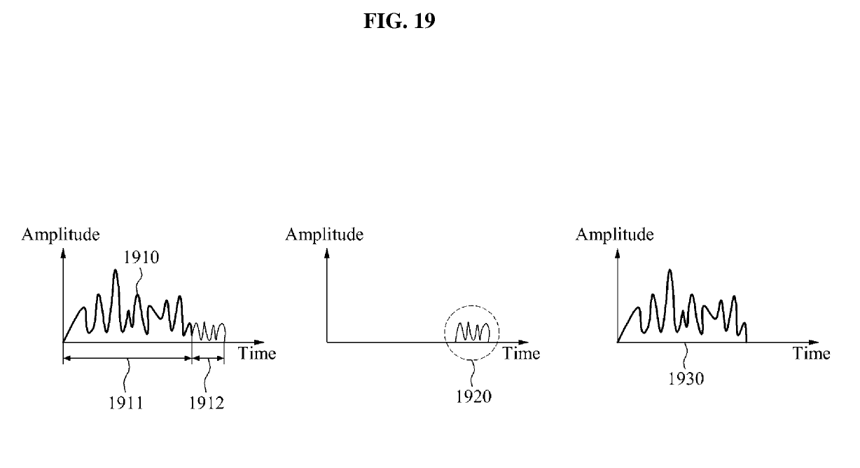

FIG. 19 is a diagram illustrating an operation of a de/framer according to an exemplary embodiment.

Referring to FIG. 19, OFDM symbols 1910 transmitted to an FFT may include an OFDM data symbol 1911 and a control symbol 1912 symbolized using BPSK.

In this instance, a de/framer included in an eDU and an eRU may extract the control symbol 1912, and detect control information 1920 framed to an OFDM frame.

Also, a resource mapper including the de/framer may perform a matching and a symbol mapping for a remaining OFDM data symbol 1930 other than the control symbol to allow concurrent transmission of I-channel and Q-channel information for a wireless channel section.

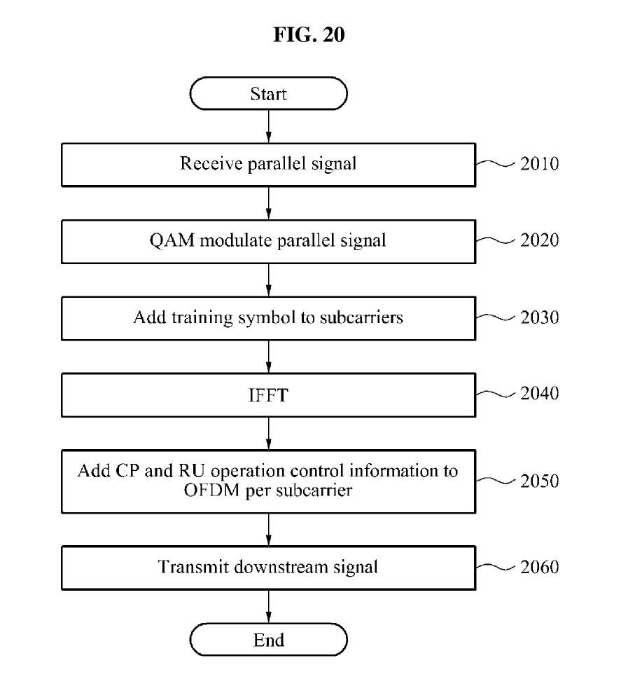

FIG. 20 is a flowchart illustrating a method of operating an eDU of a cloud base station according to an exemplary embodiment.

Referring to FIG. 20, in operation 2010, the QAM modulator 410 may receive a parallel data signal from the MAC layer unit 111.

In operation 2020, the QAM modulator 410 may perform a QAM modulation of the parallel signal received in operation 2010. In this instance, the QAM modulator 410 may receive information associated with a modulation scheme for each subcarrier from the MAC layer unit 111, perform a QAM modulation of the parallel signal using a modulation scheme for each subcarrier based on the received information, and generate the QAM modulated signal.

In operation 2030, the symbol adder 420 may add training symbols for symbol synchronization and channel estimation to the subcarriers on which the QAM modulation is performed in operation 2020.

In operation 2040, the IFFT processor 510 may perform an IFFT operation on the frequency-domain subcarriers with the training symbols added in operation 2030 to provide a time-domain OFDM sample per subcarrier.

In operation 2050, the information adder 520 may add a CP and control information for eRU operation to the OFDM sample per subcarrier output in operation 2040. In this instance, the information adder 520 may add the CP to the OFDM sample per subcarrier to avoid the time delay induced ISI and distortion caused by chromatic dispersion on the downstream signal transmitted from the eDU110.

In operation 2060, the digital to analog converter 530 may convert, to an analog signal, the time-domain OFDM sample with the CP and eRU operation control information added in operation 2050, and transmit the analog signal to an optical transceiver. In this instance, the optical transceiver may convert the received analog signal to an optical signal to generate a downstream signal, and transmit the generated downstream signal to the eRU 120.

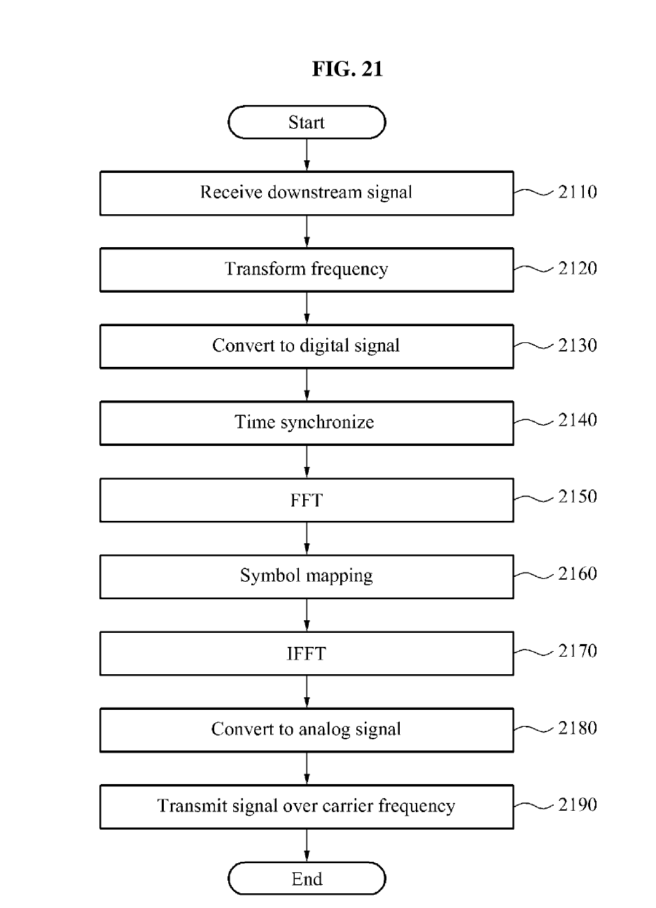

FIG. 21 is a flowchart illustrating a method of operating an eRU of a cloud base station according to an exemplary embodiment.

Referring to FIG. 21, in operation 2110, the optical OFDM receiver 121 may receive a downstream signal from the eDU 110.

In operation 2120, the frequency shifter 710 may perform a frequency shift of the downstream signal received in operation 2110. The frequency shifter 710 may identify a carrier frequency allocated to the eRU 120 for frequency shift using control information. Also, the frequency shifter 710 may perform a frequency shift in a pre-defined particular frequency band by employing a VCO.

In operation 2130, the analog to digital converter 720 may convert, to a digital signal, the signal on which the frequency shift is performed using a particular sampling frequency in operation 2120.

In operation 2140, the time synchronizer 730 may perform a timing synchronization of the digital signal converted in operation 2130. In this instance, the time synchronizer 730 may perform a timing synchronization of the digital signal at a starting point of the time-domain OFDM sample.

In operation 2150, the FFT processor 740 may perform an FFT operation on the signal on which the timing synchronization is performed in operation 2140.

In operation 2160, the resource mapper 760 may detect control information in the signal on which the FFT operation is performed in operation 2150, and perform an FFT-IFFT symbol mapping for wireless channel transmission of OFDM symbols. In this instance, the resource mapper 760 may change FFT/IFFT sizes, and perform a matching and a symbol mapping to allow concurrent transmission of I-channel and Q-channel information for a wireless section.

In operation 2170, the PHY layer unit 122 may perform an IFFT operation on the signal on which the symbol mapping is performed in operation 2160.

In operation 2180, the digital to analog converter of the RF transceiver 123 may convert the signal on which the IFFT is performed in operation 2170 to an analog signal.

In operation 2190, the RF transceiver 123 may perform a frequency shift of the signal converted to an analog signal in operation 2180 into a certain carrier frequency corresponding to a traditional mobile communication service, and transmit the signal to a subscriber's terminal.

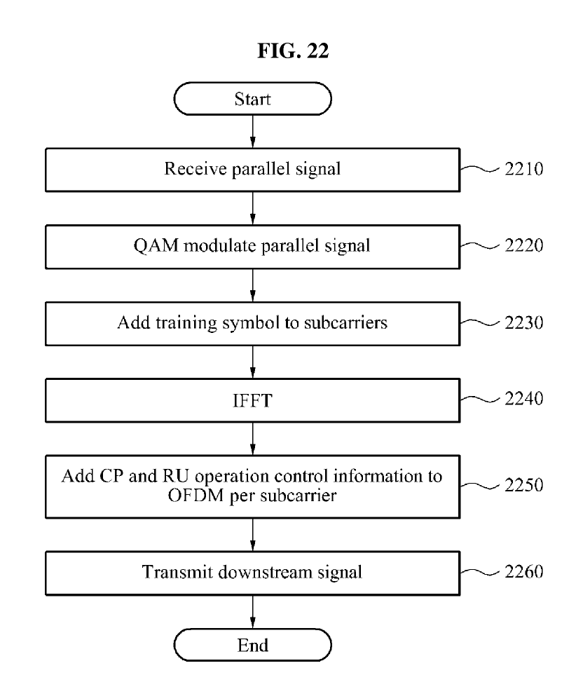

FIG. 22 is a flowchart illustrating a method of operating an eDU in a fixed-mobile converged access network according to an exemplary embodiment.

Referring to FIG. 22, in operation 2210, the QAM modulator 1310 may receive a parallel signal from the MAC layer unit 1011.

In operation 2220, the QAM modulator 1310 may perform a QAM modulation of the parallel signal received in operation 2210. In this instance, the QAM modulator 1310 may receive information associated with a modulation scheme per subcarrier from the MAC layer unit 1011, and perform a QAM modulation of the parallel signal using a modulation scheme per subcarrier based on the received information to generate QAM modulated subcarriers.

In operation 2230, the symbol adder 1320 may add training symbols for symbol synchronization and channel estimation to the subcarriers on which the QAM modulation in operation 2220.

In this instance, the resource mapper 1330 may change an FFT size, an IFFT size, and a transmission rate of modulated data per subcarrier for subcarriers or an upstream signal based on an effective transmission bandwidth used in a wireless channel section and a wired channel section. Also, the QAM modulator 1310 may perform a QAM modulation of the parallel signal received from the wireless MAC to provide QAM modulated subcarriers, and the symbol adder 1320 may add training symbols to the QAM modulated subcarriers and transmit the QAM modulated subcarriers with the added training symbols to the resource mapper 1330.

In operation 2240, the IFFT processor 1340 may perform an IFFT on the frequency-domain subcarriers with the training symbols added by the symbol adder 1320 and the subcarriers for which the FFT size, the IFFT size, and the transmission rate of modulated data per subcarrier are changed by the resource mapper 1330 in operation 2230, to provide a time-domain OFDM sample.

In operation 2250, the information adder 1350 may add a CP and control information for eRU operation to the OFDM sample per subcarrier output in operation 2240. In this instance, the information adder 1350 may add the CP to the OFDM sample per subcarrier to enable the eRU 1020 or ONU to compensate for a signal distortion caused by a time delay and a chromatic dispersion of an optical fiber.

In operation 2260, the digital to analog converter 1360 may convert, to an analog signal, the OFDM sample per subcarrier with the CP and eRU operation control information added by the information adder 1350, and transmit the analog signal to the optical transceiver 1013. In this instance, the optical OFDM transmitter 1013 may perform an electric/optic conversion of the received analog signal to generate a downstream signal, and transmit the generated downstream signal to the eRU 1020.

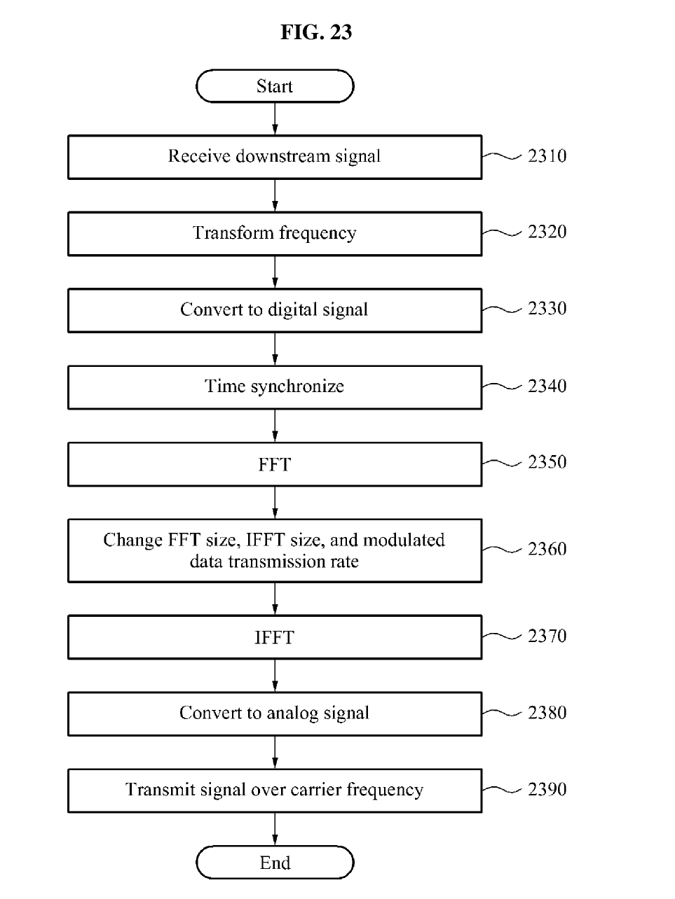

FIG. 23 is a flowchart illustrating a method of operating an eRU in a fixed-mobile converged access network according to an exemplary embodiment.

Referring to FIG. 23, in operation 2310, the optical OFDM transceiver 1021 may receive a downstream signal from the eDU 1010.

In operation 2320, the frequency shifter 1510 may perform a frequency shift of the downstream signal received in operation 2310. The frequency shifter 1510 may identify a carrier frequency allocated to the eRU 1020 for frequency shift using control information. Also, the frequency shifter 1510 may perform a frequency shift in a pre-defined particular frequency band by employing a VCO.

In operation 2330, the analog to digital converter 1520 may convert, to a digital signal, the signal on which the frequency shift is performed using a particular sampling frequency in operation 2320.

In operation 2340, the time synchronizer 1530 may perform a timing synchronization of the digital signal converted in operation 2330. In this instance, the time synchronizer 1530 may perform a timing synchronization of the digital signal at a starting point of the time-domain OFDM sample.

In operation 2350, the FFT processor 1540 may perform an FFT operation on the signal on which the timing synchronization is performed in operation 2340, and provide the signal on which the FFT operation is performed to the channel estimator 1550.

In operation 2360, the resource mapper 1560 may change an FFT size, an IFFT size, and a transmission rate of modulated data per subcarrier based on an effective transmission bandwidth used in a wireless channel section and a wired channel section.

In this instance, the resource mapper 1560 may change FFT/IFFT sizes, and perform a matching, and a symbol mapping to allow concurrent transmission of I-channel and Q-channel information for a wireless channel section. For example, the resource mapper 1560 may parallelize, to N symbols, OFDM symbols carried on one subcarrier for a wired channel section on which channel estimation is performed by the channel estimator 1550 to occupy N subcarriers for a wireless channel section.

In operation 2370, the IFFT processor 1570 may perform an IFFT operation on the signal for which the PIT size, the IFFT size, and the transmission rate of modulated data per subcarrier are changed in operation 2350.

In operation 2380, the digital to analog converter 1580 of the RF transceiver 1023 may convert the signal on which the IFFT operation is performed in operation 2370 to an analog signal.

In operation 2390, the RF transceiver 123 may transmit the analog signal converted in operation 2380 to a subscriber's terminal over a certain carrier frequency corresponding to to a traditional mobile communication service.

According to exemplary embodiments, provided is a cloud base station with cost efficiency by implementing a function of a PHY layer in a DU and an RU, rather than removing a expensive and complex CPRI framer from a legacy DU-RU separate-type base station architecture where a function of a PHY layer is only performed by a DU.

According to exemplary embodiments, a signal may be transmitted and received in a lower transmission bandwidth than that of a traditional technology by implementing communication channel using a subcarrier group allocated differently based on a combination of DU-RU.

According to exemplary embodiments, a long-distance signal transmission may be achieved with reduced costs associated with a PHY by transmitting and receiving information received via a plurality of radio channel links using one optical link.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A cloud radio base station comprising:
a physical (PHY) layer unit to perform a quadrature amplitude modulation (QAM) of a parallel signal received from a media access control (MAC) layer per subcarrier; and
an optical orthogonal frequency division multiplexing (OFDM) transceiver to transform the QAM modulated subcarriers into a time domain to generate an OFDM sample per subcarrier, add a cyclic prefix (CP) and control information for operating an enhanced radio unit (eRU) to the OFDM sample per subcarrier to generate a downstream signal, and transmit the downstream signal.

2. The cloud radio base station of claim 1, wherein the PHY layer comprises:
a QAM modulator to perform a QAM modulation of the parallel signal using a modulation scheme per subcarrier based on information received from the MAC layer; and
a symbol adder to add training symbols for symbol synchronization and channel estimation to the QAM modulated subcarriers, and transmit the QAM modulated subcarriers with the added training symbols to the optical OFDM transceiver.

3. The cloud radio base station of claim 1, wherein the optical OFDM transceiver comprises:
an inverse fast Fourier transform (IFFT) processor to perform an IFFT on the QAM modulated subcarriers of a frequency domain to provide a time-domain OFDM sample per subcarrier; and
an information adder to add a CP and control information for operating an eRU to the OFDM sample per subcarrier.

4. The cloud radio base station of claim 3, wherein the optical OFDM transceiver converts the OFDM sample per subcarrier with the added CP and control information for operating the eRU to an analog signal, and transmits the analog signal to an optical transceiver, and
the optical transceiver performs an electric/optic conversion of the analog signal received from at least one optical OFDM transceiver to generate a downstream signal, and transmits the generated downstream signal to an eRU.

5. The cloud radio base station of claim 1, wherein the subcarrier is allocated flexibly to an eRU receiving the OFDM sample per subcarrier.

6. A cloud radio base station comprising:
an optical orthogonal frequency division multiplexing (OFDM) receiver to perform a frequency shift of a downstream signal received from an enhanced radio unit (eRU) per subcarrier, perform a timing synchronization, and perform a channel estimation;
a physical (PHY) layer unit to perform an inverse fast Fourier transform (IFFT) on the channel estimated signal; and
a RF transceiver to transmit the signal on which the IFFT is performed to a subscriber's terminal over a certain carrier frequency corresponding to a mobile communication service.

7. The cloud radio base station of claim 6, wherein the optical OFDM receiver comprises:
a frequency shifter to perform a frequency shift of the downstream signal received from the eRU per subcarrier;
a time synchronizer to perform a timing synchronization of the frequency shifted signal; and
a channel estimator to perform a channel estimation of the timing synchronized signal per subcarrier.

8. The cloud radio base station of claim 7, wherein the frequency shifter identifies a carrier frequency allocated for frequency shift using control information, and performs a frequency shift in a preset particular frequency band by employing a voltage controlled oscillator (VCO).

9. The cloud radio base station of claim 7, wherein the optical OFDM receiver to further comprises:
a analog to digital converter to convert the frequency shifted signal using a particular sampling frequency to a digital signal, and
the time synchronizer performs a timing synchronization of the digital signal at a starting point of a time-domain OFDM sample.

10. The cloud radio base station of claim 7, wherein the optical OFDM receiver further comprises:
a fast Fourier transform (FFT) processor to perform an FFT on the time synchronized signal and provide the signal on which the FFT is performed to the channel estimator; and
a resource mapper to detect control information in the channel estimated signal and perform an FFT-IFFT symbol mapping for wireless channel transmission of OFDM symbols.

11. The cloud radio base station of claim 10, wherein the resource mapper changes FFT/IFFT sizes, performs a matching, and performs an operation processing of the symbol mapped signal, to allow concurrent transmission of in-phase (I)-channel and quadrature (Q)-channel information for a wireless channel section.

12. The cloud radio base station of claim 10, wherein the resource mapper frames control information for operating the eRU to an OFDM frame and transmits the OFDM frame to the eRU.

13. The cloud radio base station of claim 12, wherein the control information for operating the eRU comprises at least one of data synchronization, frequency synchronization required for operating an antenna and a VCO, and automatic gain control information of a radio frequency (RF) amplifier operating the antenna.

14. A radio base station in a fixed-mobile converged access network, the radio base station comprising:
a physical (PHY) layer unit to transform a parallel signal received from a media access control (MAC) layer into quadrature amplitude modulation (QAM) modulated subcarriers in a time domain to generate a signal per subcarrier, and add a cyclic prefix (CP) to the signal per subcarrier to generate a downstream signal; and
an optical orthogonal frequency division multiplexing (OFDM) transceiver to perform an electric/optic conversion of the downstream signal and transmit the downstream signal to the eRU.

15. The radio base station of claim 14, wherein the PHY layer comprises:
a QAM modulator to perform a QAM modulation of the parallel signal using a modulation scheme per subcarrier based on information received from the MAC layer;
a symbol adder to add training symbols for symbol synchronization and channel estimation to the QAM modulated subcarriers, and transmit the QAM modulated subcarriers with the added training symbols to the optical OFDM transceiver;
an inverse fast Fourier transform (IFFT) processor to perform an IFFT on the QAM modulated subcarriers of a frequency domain to generate a time-domain OFDM sample per subcarrier; and
an information adder to add a cyclic prefix (CP) to the signal per subcarrier to compensate for a signal distortion caused by a time delay and a chromatic dispersion of an optical fiber.

16. A radio base station in a fixed-mobile converged access network, the radio base station comprising:
to a frequency shifter to perform a frequency shift of a downstream signal received from an eRU per subcarrier;
a time synchronizer to perform a timing synchronization of the frequency shifted signal;
a fast Fourier transform (FFT) processor to perform an FFT on the time synchronized signal;
a channel estimator to perform a channel estimation of the signal, on which the FFT is performed, per subcarrier;
a resource mapper to change an FFT size, an IFFT size, and a transmission rate of modulated data per subcarrier based on an effective transmission bandwidth used in a wireless channel section and a wired channel section;
a physical (PHY) layer unit to perform an inverse fast Fourier transform (IFFT) on the signal for which the FFT size, the IFFT size, and the transmission rate of modulated data per subcarrier are changed; and
a RF transceiver to transmit the signal on which the IFFT is performed to a subscriber's terminal over a certain carrier frequency corresponding to a mobile communication service.

17. The radio base station of claim 16, wherein the frequency shifter identifies a carrier frequency allocated for frequency shift using control information, and performs a frequency shift in a pre-defined particular frequency band by employing a voltage controlled oscillator (VCO).

18. The radio base station of claim 16, wherein the time synchronizer further comprises:
a analog to digital converter to convert the frequency shifted signal using a particular sampling frequency to a digital signal, and
the time synchronizer performs a timing synchronization of the digital signal at a starting point of a time-domain OFDM sample.

19. The radio base station of claim 16, wherein the resource mapper changes FFT/IFFT sizes, and performs a matching, and a symbol mapping to allow concurrent transmission of in-phase (I)-channel and quadrature (Q)-channel information for the wireless channel section.

20. The radio base station of claim 19, wherein the resource mapper parallelizes OFDM symbols carried on one subcarrier for the wired channel section to N symbols to occupy N subcarriers for the wireless channel section.
